(19) United States
(12) Patent Application Publication
(10) Pub. No.: US 2005/0044777 A1
(43) Pub. Date: Mar. 3, 2005

(54) Insect Trap

(76) Inventor: William Charles Hiscox, Spokane, WA (US)

Correspondence Address: GREENBERG & LIEBERMAN, 314 PHILADELPHIA AVE., TAKOMA PARK, MD, 20912, US

(21) Appl. No.: 10/707,699

(22) Filed: Jan. 5, 2004

Related U.S. Application Data
(60) Provisional application No. 60/481,317, filed on Aug. 30, 2003.

(51) Int. Cl. A01M 1/06

(52) U.S. Cl. 43/139

(57) ABSTRACT

An attractant based insect trap has a fan placed close to an insect attractant. The insect attractant creates an attractive smell, taste or other olfactory sensation that elicits an attractive response in the insect. The flying insect moves toward the fan mechanism against the flow of attractant-laden air, in order to reach the source of the attractant. The flying insect enters the trap, toward the source of the smell, which is the fan. The entrance to the trap leads into a bag, into which the insect moves to find the source of the attractant, and is trapped within the bag. The user may easily remove the bag from the interior of the trap, and dispose of the bag in a refuse receptacle. A new bag is then placed in the interior of the insect trap, and the trap is ready to trap more insects.

### BACKGROUND OF INVENTION

The present invention is an insect trap, more specifically a means for capturing insects and dehydrating the insect bodies for easy disposal.

There are several types of insect traps in use today to control or monitor pest insects. In the case of flies, existing traps suffer from various drawbacks. For example, sticky fly tape and other devices, which depend on a glue board or other sticky surface to trap the flies, can only catch a limited number of flies. The tape becomes messy and unsanitary, and live flies can be seen and heard as they fight to get free of the tape. Fly parts and other debris fall from the tape, making it a nuisance. Furthermore, there is no attractant that can be used effectively with this type of trap.

Traps which rely on an attractant dispersed in water, and which drown the flies once they have entered, become unbearably pungent once a number of flies have been caught, due to bacterial breakdown of the carcasses. The traps themselves become unhygienic and objectionable to people. Disposal of such traps after use also presents a problem, in that they are a bag full of bacterial soup which must be sealed tightly in another plastic bag, etc. in order to contain the odor and filth. This type of trap cannot be used indoors or anywhere near people.

Traps that depend on an ultraviolet light source to lure flying insects, including flies, are in common use, but are not very effective. Flies are still caught using a sticky tape in many of these devices. Even more sophisticated light traps, employing a fan to blow insects into the trap, do not perform well in real world situations.

Fly traps which rely on the aggregation/sex pheromone for the housefly, Z-9-tricosene are also known to be ineffective unless the pheromone can be made volatile enough to be dispersed in the air. Several methods of dispersal have been tried, including resistive heating of the pheromone and agitation with a piezoelectric device. None of these methods results in a truly effective fly trap.

Thus, there is no single effective means of trapping flies and other insects which can be used to effectively control flies without causing an offensive odor and creating a health hazard due to the accumulation of dead, decaying flies.

Therefore a need has been established for a means to control flies and other flying insects, which emits no foul odor, and creates no health risk to users.

### SUMMARY OF INVENTION

An attractant based insect trap is disclosed. The insect trap has a fan placed close to an insect attractant. The insect attractant functions by creating an attractive smell or taste, or otherwise triggering an attractive response in insects. Volatile insect attractants include, but are not limited to, pheromones, other semiochemicals (a class of chemical compounds which elicit a behavioral response in animals when exposed to the particular chemical, either through antennal response or through any other olfactory organ), food-based volatiles, volatiles of feces, and volatiles produced by live and decaying plants and animals. In the present invention, the flying insect moves towards the fan, as well as towards the attractant. The flying insect, in trying to reach the attractant, is drawn into a plastic bag in the interior of the insect trap; and essentially, the insect is then trapped in the interior of the insect trap until such time as the insect is dried or dehydrated by the flow of air. The user may easily remove the bag from the interior of the trap, and dispose of the bag in a refuse receptacle. A new bag is then placed in the interior of the insect trap, and the trap is ready to trap more insects. Alternatively, a trap constructed in the same way, except without a bag or other catch receptacle other than the outer wall of the trap, functions in the same way, as long as air carrying the attractant is circulated throughout the trap.

The bag is either a plastic drawstring bag or a bag fitted with an elastic band or other means of closure, which can be produced of a clear or opaque material. The bag may be substituted by a rigid cup or other vessel, with appropriate modification of the trap. The attractant dispenser can be housed in the interior of the plastic bag, or can be used as a separate piece below the fan or between the fan and the catch bag. The fan mounting block can be equipped with a hook material to fasten to the exposed part of the attractant pad, which incorporates a fibrous loop material, or to the outside bottom of the bag, which can be fitted with loop material, thus making a hook-and-loop closure (commonly known as Velcro®). Alternatively, another means of sealing the bag to the fan may be used, including, but not limited to, a magnetic seal, weight in the bottom of the bag, glue or double-sided tape, or a latching mechanism or snap-in feature. In some embodiments of the present invention, a bag is not used, but instead the entire trap is disposable, allowing a user to replace the trap without having to worry about changing bags in the trap.

The bag is held against the fan port, such that a hole in the bottom of the bag is held directly over the fan, and the bag bottom is anchored to the fan mounting plate such that there is a positive seal between the hole in the bag and the fan port.

### BRIEF DESCRIPTION OF DRAWINGS

FIG. 1 shows a schematic side view of one embodiment of the present invention.

FIG. 2 shows a schematic side view of a second embodiment of the present invention.

FIG. 3 shows a schematic side view of a third embodiment of the present invention.

FIG. 4 shows a bottom view of the catch bag of the third embodiment of the present invention.

FIG. 5 shows a schematic side view of the third embodiment with a bag with elastic closure which seals around the entrance funnel, rather than the outer wall.

FIG. 6 shows a fourth embodiment of the present invention in which the funnel portion of the entrance is replaced by a number of fibers arrayed 360 degrees around the entrance, allowing one-way entrance into the trap.

FIG. 7 shows a schematic side view of the fifth embodiment, a trap with no internal collection bag, and with multiple openings.

FIG. 8 shows a schematic side view of a sixth embodiment of the present invention, incorporating a catch cup, rather than a bag.

FIG. 9 shows a schematic side view of a seventh embodiment of the present invention in which there is no catch bag, but there is a separate chamber for collecting flies which is a fixed part of the trap.

### DETAILED DESCRIPTION

The present invention is an insect trap using an insect attractant and a fan for dispersing attractant and desiccating the trapped insects. Each of the embodiments of the present invention has some common elements to the other traps. Each trap has an entrance structure, which emits a plume of attractant, and allows a space for the insects to enter the trap. Additionally, the entrance structures all have a means of circulating the attractant-laden air back through the trap.

Flying insects, in all embodiments of the present invention, enter against the flow of the air, attempting to follow the attractant-laden air to its source. Each embodiment of the present invention has a collection area to prevent the escape of flying insects and for easy disposal of the insect carcasses. Each of the collection areas may be treated with an anti-microbial agent to prevent pungent smells common to other flytraps. Each embodiment of the present invention has a fan (or other method of circulating air) to circulate the attractant-laden air through the trap and out the entrance to attract flying insects. Each of the embodiments of the present invention has a means for circulating an attractant that can emanate from an attractant cartridge and be in powdered or liquid form. The chemical make-up of the attractant is not specific to the trap, and any effective attractant may be used in the traps. The attractant may be renewed by use of a syringe that distributes the attractant in metered amounts over time for dispersal, or by any other known means of controlled or passive release of attractants.

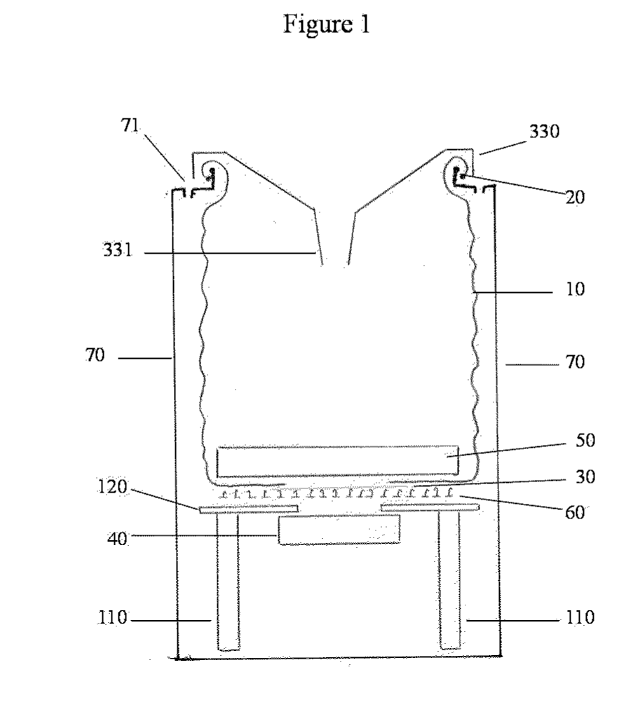

FIG. 1 shows a first embodiment of the present invention with a bag (10), an elastic seal (20) for the bag (10), a fan (40), an attractant pad (50), a removable foil seal (30) under the attractant pad (50), hook and loop material (60), and the outer wall (70) of the present invention. The general concept is to position the fan (40) under the bag (10) so that air flows upwards. Insects or flies enter the bag (10) from a funnel-like entrance (331), which is part of the entrance cap (330), and are drawn into the bag (10) against the flow of air from the fan (40). The fan (40) is disposed below the attractant pad (50) so that the attractant pad (50) receives the upward air flow from the fan (40) to assist in dispersing attractant.

The elastic seal (20) for the bag (10) allows the bag (10) to be drawn closed when it is full of insects for removal. In use, the elastic seal (20) of the bag (10) is stretched around the opening of the outer wall (70), and locked in place by the tight fitting entrance cap (330). The funnel-like entrance (331) portion of entrance cap (330) allows entrance of insects into the interior of the catch bag. The removable foil seal (30) is a cover that goes over the attractant pad (50) to prevent premature exposure of its contents during shipping and storage, and the hook and loop material (60) permits attractant pad (50) to attach to the fan (40) for tight air flow when the fan (40) is engaged.

The elastic seal (20) is a ring, which closes automatically to seal the bag when it is removed from the trap. Alternatively, the bag (10) can be threaded with a string, so that the string can be pulled to draw the elastic seal (20) together to tightly close the bag (10) and dispose of the insect carcasses.

In operation, the fan (40) blows air current through the attractant pad (50) and attracts insects because, conventionally, insects are lured to the substance(s) formulating the attractant pad (50). The fan (40) blows air against the incoming insects, but the insects fight the air flow and remain near the attractant where they eventually dry out. Thus, the fan (40) serves a dual purpose first, the fan (40) disperses the attractant from the attractant pad (50); but second, the fan (40) maintains an air flow which desiccates the insects within the bag (10). The constant flow of air into the bag (10) dries the insects, much like a dehydration chamber. In this embodiment, the attractant pad (50) assures that the insects cannot escape the trap from below.

FIG. 1 is remarkable as an embodiment in that the bag (10) can be manufactured with the attractant pad (50) attached at its bottom. Thus, with the foil seal (30) in place under the attractant pad (50) and attached to the bottom of the bag (10), the attractant pad (50) is completely sealed for shipping without danger that attractant will leak if the elastic seal (20) is also closed at the top of the bag (10).

In this, as well as all other embodiments of the present invention, it is possible to include a light for attracting insects, as well as other means of attracting insects, without otherwise changing the function of the trap.

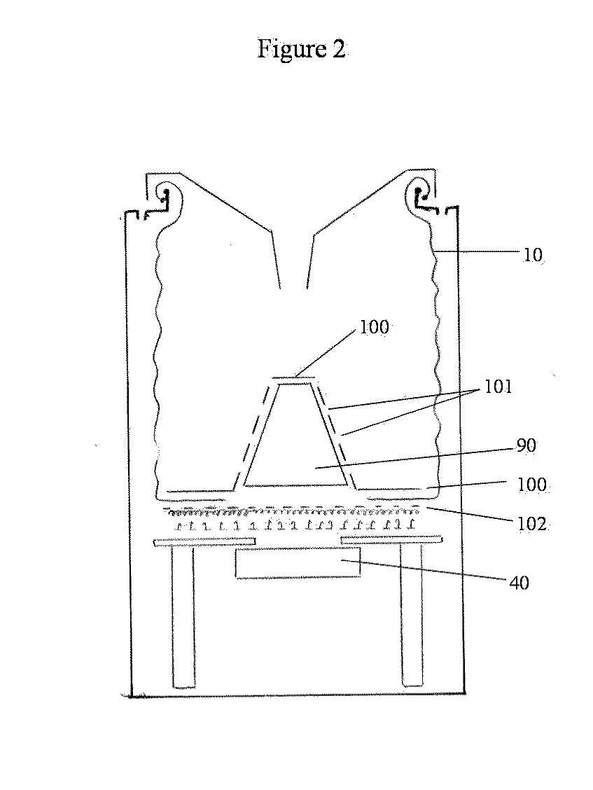

FIG. 2 is a schematic view of a second embodiment of the present invention with a bag (10) and a cone attractant (90). The cone attractant (90) fits into a cone-shaped plastic insert (100), with holes (101) in the side of the insert (100) to allow air to flow from the fan (40), through the cone attractant (90), and into the bag (10). In this embodiment, the catch bag (10) is constructed in such a way that there is a hole in the bottom of the bag (10) to allow airflow to the cone attractant (90). The cone-shaped insert (100) is fitted into the bottom of the catch bag (10), then a cone attractant (90) is inserted into the cone-shaped insert (100). A loose mesh plastic screen (102) with the loop portion of a hook-and-loop closure is placed over the bottom of bag (10), then the three layers—100, 10 and 102—are welded together to form the rigid bottom of the bag (10). In this embodiment, the fan (40) is placed beneath the porous cone attractant (90) for maximum attractant dispersal in the bag (10). The bag (10) allows flying insects to have an enclosed space in which they are desiccated by the constant air circulation of the fan (40). In this embodiment, air flows from the fan (40) into and through the porous cone attractant (90), entering the bag (10) through holes (101) in the cone-shaped insert (100). The cone attractant (90) is intended for longer use than the attractant pad (FIG. 1, 50). This is because as flies enter the catch bag (10) of the first embodiment, containing attractant pad (50), they die and collect at the bottom of the bag, covering attractant pad (50) and potentially blocking airflow. In the case of the second embodiment, where a cone attractant (90) is used, more flies may collect at the bottom of bag (10) before blocking the airflow from the cone attractant (90). The longer the physical length of the cone attractant (90), the more flies can be caught without blocking airflow. Also, the cone attractant (90) presents the following advantages over the attractant pad (50) of FIG. 1: Cone attractant (90) provides more surface area of attractant-bearing material comprising cone attractant (90) for contact with flowing air than attractant pad (50), which has only the portion of the pad directly over fan (50) available to airflow contact. Thus, more attractant can be contained and delivered over a longer period of time using the cone attractant (90). One potential disadvantage of cone attractant (90) and the associated cone-shaped insert (100) and mesh backing with loops (102) is the added cost due to the use of extra parts (100) and (102). However, it is also possible to use a one-piece cone attractant (90), made of a rigid, porous material that can be welded into the bottom of the bag.

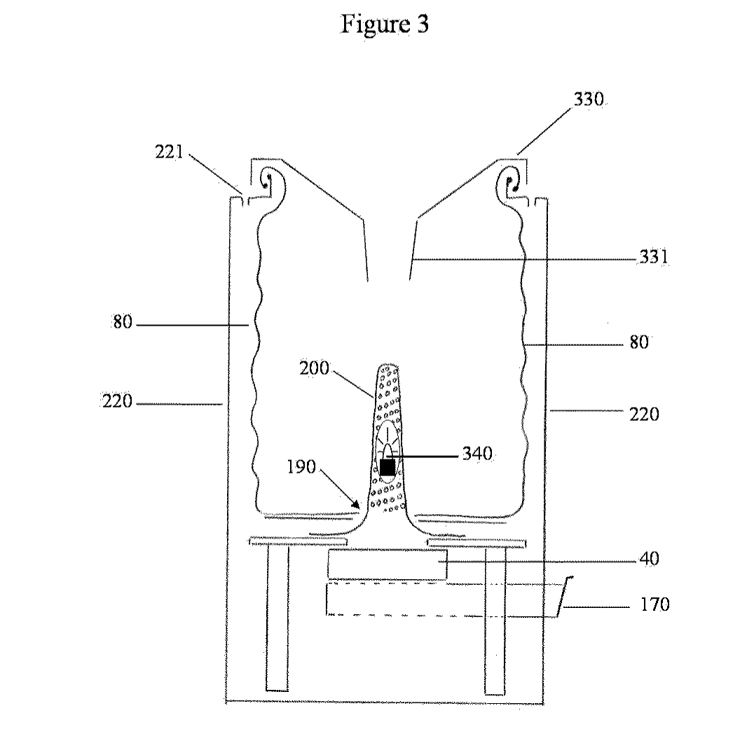

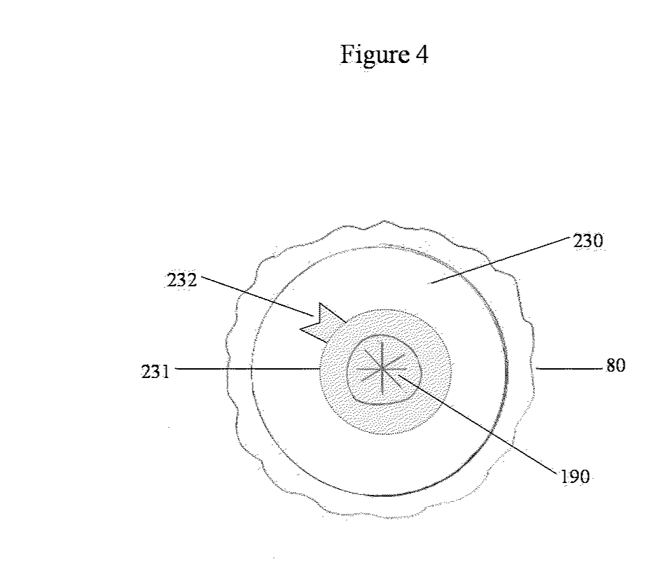

FIG. 3 shows a schematic view of a third embodiment of the present invention with a removable attractant cartridge (170), the bag (80), a star opening (190) on the bottom of the bag (80), an air flow pedestal (200), the fan (40), and an outer wall (220) with return air holes (221) located just outside of the entrance cap (330) on the top portion of outer wall (220). In this embodiment of the present invention, the fan (40) is disposed beneath an airflow pedestal (200). The airflow in this embodiment is moved out of the top of the bag (80), through the narrow funnel inlet (331) of the entrance cap (330), returning to the trap through return holes (221) in the outer wall (220). Airflow continues downward between the exterior of the bag (80) and the outer wall (220) to reach the attractant cartridge (170), pulled by the fan (40), which moves the air into the interior of the catch bag (80) by way of the airflow pedestal (200). Thus, the recirculated air is pulled through the attractant cartridge (170), to be distributed as attractant-laden air in the bag (80). The airflow pedestal (200) sits above the fan (40). The airflow pedestal (200) can be constructed of a clear plastic, and in some embodiments, may incorporate a lamp (340, shown as a cutaway view in the airflow pedestal (200)) to further lure insects into the depths of bag (80). A lamp (340) or other light source may be used in any of the embodiments of the present invention, and will enhance the catch of many species of insects. The perforated airflow pedestal (200) keeps the insect carcasses from blocking the fan (40) as they collect in the bag (80) because of its shape that is, the insects fall to the side of the airflow pedestal (200). The fan (40) circulates return air from the return holes (221), between the outer wall (220) and the outside of the bag (80), over the removable attractant (170). Removable attractant (170) sits below the airflow pedestal (200) and fan (40). The flow of air allows the smell of the removable attractant (170) to circulate from the airflow pedestal (200) and throughout the bag (80) to the funnel-like entrance (331) of the entrance cap (330), where it exits the trap creating a plume of attractant outside the entrance of the trap. Around the airflow pedestal (200) is the star opening (190) of the bag (80) that creates a secure opening for the airflow pedestal (200) to fit within. The star opening (190) is shown in greater detail in FIG. 4. It is to be understood that the removable attractant (170), unlike previous embodiments, is positioned under the fan (40), and thus, it is easy to replace without disturbing the rest of the present invention. Replacement of the removable attractant (170) is possible because it can simply slide horizontally in and out through the outer wall (220). A variation of the removable attractant (170) allows air to flow through the removable attractant (170) via the side of the removable attractant cartridge (170), thus representing an air inlet into the present invention, but the air must travel through the removable attractant to enter the system of the present invention.

FIG. 4 shows the star opening (190) that is utilized in the third embodiment in FIG. 3. The star opening (190) is surrounded by a reinforcing piece (230), which can be constructed of metal, cardboard, or a thicker plastic than the bag (80). The reinforcing piece (230) provides structure around the bendable star opening (190) so that there is a solid base upon which the star opening (190) can flex. The star opening (190) is useful in conjunction with the bag (80) to ensure simple and air tight communication between the airflow pedestal (FIG. 3, 200) and the bag (80). Also shown in FIG. 4 is the removable foil or foil laminate seal (231) with a tab (232) attached for removing the foil seal (231) from the bottom of the bag (80) and reinforcing piece (230).

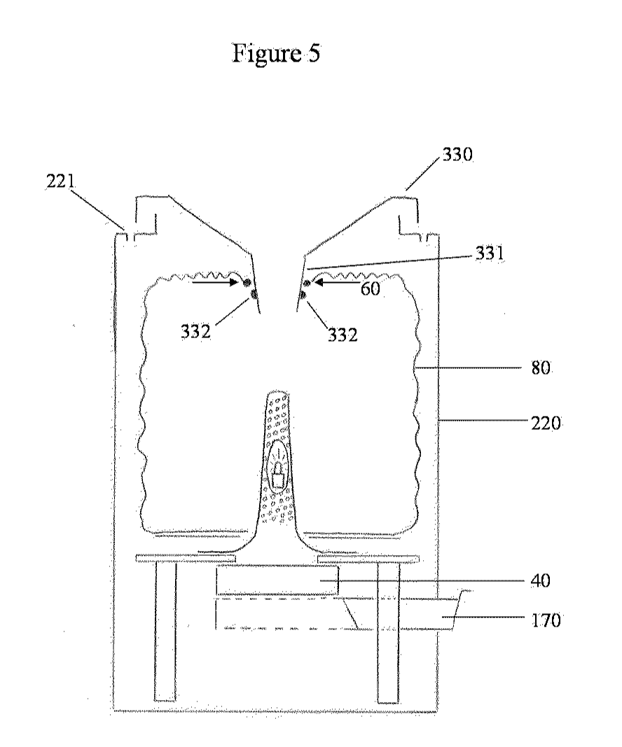

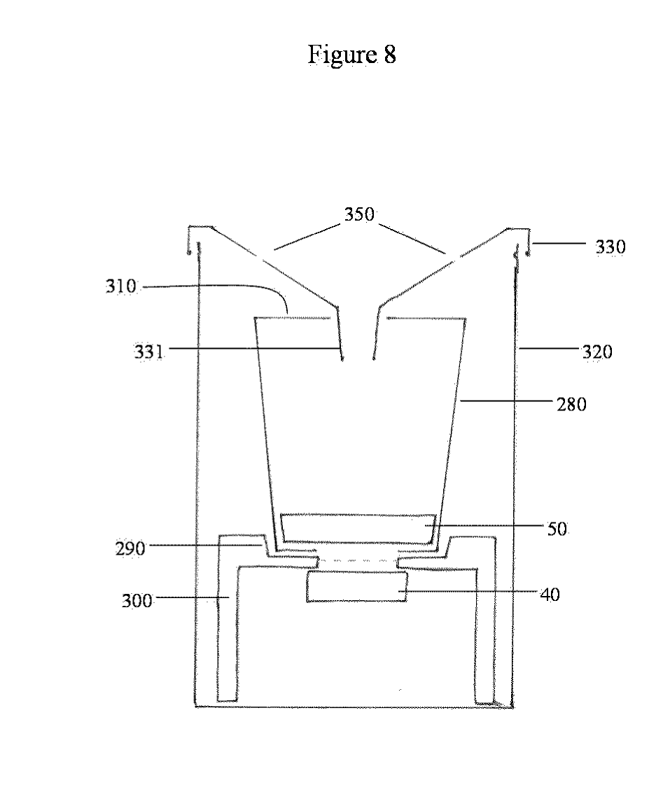

FIG. 5 shows a schematic view of a fourth embodiment of the present invention, in which the bag (80) and the elastic seal (60) are configured to seal around the narrow funnel entrance (331) of the entrance cap (330). In this embodiment, a bead or ring (332) is built into the outer circumference of the entrance funnel (331) portion of entrance cap (330), such that the elastic seal (60) of the bag (80) will seal tightly around the funnel (331) without slipping off. The arrows show the direction of the elastic force of the elastic seal (60). The elastic seal (60) can be constructed to fit wide or narrow openings, depending upon the shape of outer wall (220), the configuration and shape of the entrance, and other considerations. The bag (80) is not limited to vertical placement, but can be placed horizontally, or diagonally in alternate traps. The bag (80) is made of a thin plastic material. The bag (80) may be constructed of other materials, such as paper, or metallic alloys, but plastic is the preferred construction because it is inexpensive and lightweight. It should be noted that the return air holes (221) may be replaced in this embodiment by return holes (350) located in the entrance cap (330) itself (described in the seventh embodiment of the present invention, shown in FIG. 8).

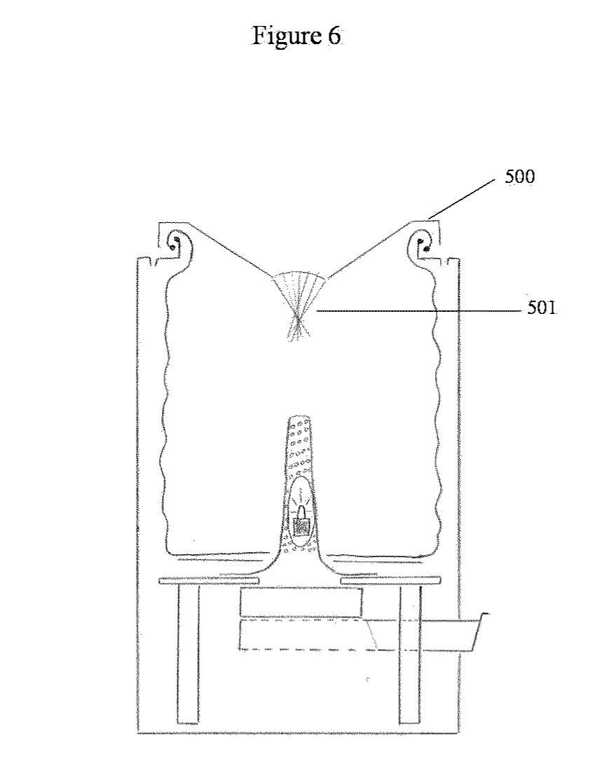

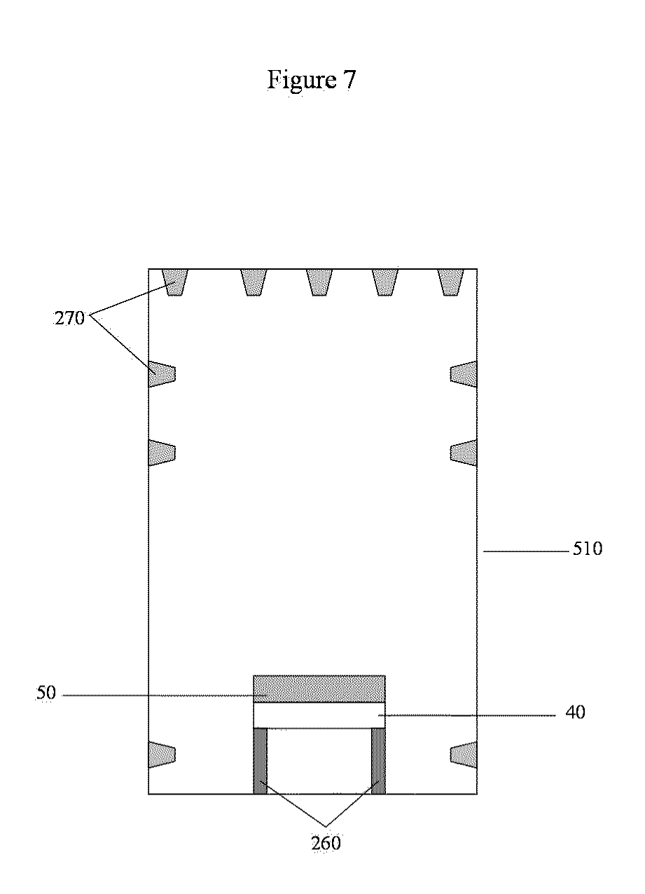

FIG. 6 is a schematic drawing of a fifth embodiment of the present invention. In this embodiment, the solid funnel type entrance (331) of the entrance cap (300) has been replaced by a concentric series of fibers (501) bonded to the entrance cap, which meet at an apex below the trap entrance to form a funnel-like basket entrance (501, which is part of the entrance cap (500)). The fibers would give way when the insect attempts to enter the trap, but would create a hindrance should the insect attempt to leave the trap through the funnel-like basket entrance (501). The fibers only move in a manner to allow the insects to enter the trap and would not move to allow the insects to open the funnel-like basket entrance (501) enough to vacate the trap. In this manner, when insects attempt to vacate the trap, the fibers would only close the funnel-like basket entrance (501) tighter, leaving no escape route. The fibers can be constructed of any semi-rigid material, and can be tailored to meet the needs of different types of flying or crawling insects. Additionally, the fibers may be manufactured as part of the entrance structure (i.e. 501 and 500 are one piece), or attached separately to the lower portion of the entrance cap (500). The fibers may be manufactured in any color, or clear so that the insects are unable to perceive the barrier. The fiber method can be used with any attractant, pheromone, semiochemical, or any other method of luring the insects into the trap. The method of construction of the fiber entrance (501) is different from previous methods (U.S. Pat. No. 6,158,165, Henry Allen Wilson), since the fibers are constructed from plastic, rather than wire, and are attached directly to, or are part of, the entrance structure (500), rather than held there by a metal ring, as in the Wilson patent. FIG. 7 shows an alternate sixth embodiment of the present invention with no bag (80). This embodiment has several openings (270) across the top and sides of container (510) for entry of insects. This embodiment has a fan (40) on legs (260) with an attractant pad (50) above the fan (40) for circulating the attractant in the trap. This embodiment functions like the other embodiments such that some attractant will escape through openings (270) while much of the attractant will follow convection currents and be circulated again via fan (40), as the airflow travels from under legs (260), through the fan (40), through the attractant pad (50), and into the container (510) and back under legs (260) etc.

FIG. 8 shows a seventh embodiment of the present invention without a bag (80). This embodiment has a catch cup (280) design with outer wall (320). The catch cup (280) has a hole in the bottom of the cup to allow air from the fan (40) into the catch cup (280), and has fixed across the top a thin film (310) of plastic or other membrane, which has been star-cut in the center of thin film (310), much like the bag (80) in FIG. 4. The star cut in the thin film (310) allows the narrow funnel portion (331) of the entrance cap (330) to penetrate the thin film (310), and also allows the penetration point to “heal”, once the entrance cap has been removed, thus preventing escape of insects when the catch cup (280) is replaced with a new catch cup (280). In this embodiment, the catch cup (280) is fitted with attractant pad (50), so that attractant pad (50) completely covers the hole in the bottom of the catch cup (280), allowing air to pass from the fan (40) through the attractant pad (50), but not allowing escape of insects through the bottom of the catch cup (280). A fan mounting base (300) is constructed with mounting posts to hold the fan above the bottom portion of outer wall (320), and is designed to allow air to flow freely to the fan (40). In this embodiment, the fan (40) is mounted under the base (300) in the center of the base (300), through which there is a hole large enough for air to easily flow from the fan (40). This hole may be covered with a screen, but it is not necessary to function. The top of the base (300) incorporates an indentation or cradle (290) which is designed to accept and to hold in place the narrower bottom of the catch cup (280). The catch cup (280) is held firmly in place laterally by the sides of the cradle (290), and held firmly against the cradle by the force exerted from the entrance cap (330), when the entrance funnel (331) of the entrance cap (330) is fully inserted in the star cut of the catch cup (280), and the entrance cap (330) is locked to the sides of outer wall (320). The entrance cap (330) is designed to hold the catch cup (280) against the fan outlet portion of the cradle (290). Airflow is from the fan (40) through the hole in the cradle (290) portion of the base (300), then into the catch cup (280), entering through the attractant pad (50). Air continues through the catch cup (280), out of the trap through the funnel-like entrance (331), then returning to the space between catch cup (280) and outer wall (320) through small holes (350) in the entrance cap (330), located above and away from catch cup (280) as shown in FIG. 8.

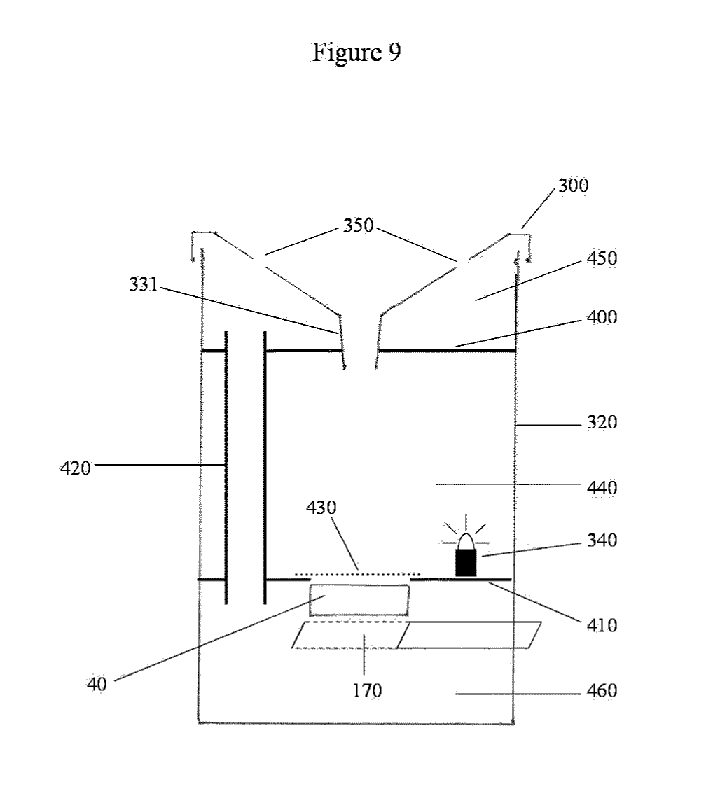

An eighth embodiment is shown in FIG. 9, which is also an alternate embodiment in which there is no catch bag or cup. In this embodiment, the catch chamber is separated from other chambers of the trap, but it is an integral part of the trap. In this embodiment, the inner surface of the outer wall (320) is spanned entirely by a flat plate (410), into which two holes have been cut: one in the center of the plate for the fan (40), and one offset, to accommodate the bypass tube (420). A second top plate (400) also spans the inner dimension of the outer wall (320), and holes are cut to accommodate the funnel like entrance (331) in the center of the top plate (400), and the upper portion of the bypass tube (420). The fan (40) is mounted under the lower plate (410), and is covered by a screen (430), such that trapped insects do not fall through the screen (430) into the fan (40). The chamber, defined as the space between the lower plate (410) and the upper plate (400) excluding the space filled by the bypass tube (420), is the insect catch chamber (440). Air flows from the fan (40) through the screen, into the catch chamber (440), out of the trap through the funnel-like entrance (331), returning to an upper chamber (450) of the trap through holes (350) in the trap entrance cap (300), then continuing downward through the bypass tube (420) to the lower chamber (460), where an attractant cartridge (170) may be used to introduce attractant into the air stream. In this way, recirculated air is pulled through the attractant cartridge (170) by the fan (40) to complete the circuit. As an alternative to the attractant cartridge (170), any of the previously described methods of containing and dispersing attractant are adequate for this embodiment. The attractant may also simply be placed in the lower chamber (460) of the trap, where a steady flow of air from the fan (40) passes over it, releasing the volatile components into the air stream. Trap performance is enhanced by incorporation of a lamp (340) or other light source. It is also important to note that the function of the bypass tube (420) may be satisfied by another means of commuting the air flow, such as a double wall or partition. In fact, the catch bags described in several earlier embodiments and catch cup (280) of the seventh embodiment shown in FIG. 8, represent this type of structure, except that they are removable.

The present invention is not limited to the sole embodiments described above, but encompasses any and all embodiments within the scope of the following claims.

1. A trap, comprising:
an entrance structure;
an attractant dispensing mechanism that releases an attractant, said attractant dispensing mechanism adjacent to said entrance structure; and
an attractant circulation means in communication with said attractant dispensing mechanism.

2. The trap of claim 1, further comprising a collection area adjacent to said
attractant dispensing mechanism.

3. The trap of claim 2, wherein said collection area has an anti-microbial
agent.

4. The trap of claim 1, further comprising a light in communication with said
entrance structure.

5. The trap of claim 2, wherein said attractant circulation means moves the
attractant through said collection area.

6. The trap of claim 2, wherein said collection area receives insects but
prevents the insects” exit.

7. The trap of claim 1, wherein said attractant dispensing mechanism is a
cartridge.

8. The trap of claim 1, wherein said attractant dispensing mechanism
contains attractant as a powder or liquid.

9. The trap of claim 1, wherein said attractant dispensing mechanism
distributes the attractants in metered amounts over time.

10. A trap, comprising:
a bag;
an elastic seal, in communication with said bag;
a fan, in communication with said bag;
an attractant container, in communication with said fan; and
a removable seal, in communication with said attractant container.

11. The trap of claim 10, wherein said attractant container is a pad.

12. The trap of claim 10, wherein said attractant container is of a conical
shape.

13. The trap of claim 10, wherein said attractant container is a cartridge.

14. The trap of claim 10, wherein said bag has an opening at its bottom.

15. The trap of claim 14, wherein said opening is in the shape of a star.

16. The trap of claim 10, further comprising a light in communication with said bag.

17. The trap of claim 10, further comprising an outer wall in communication
with said bag.

18. The trap of claim 10, further comprising an airflow pedestal in
communication with said fan.

19. The trap of claim 14, further comprising a reinforcing piece in
communication with said opening.

20. The trap of claim 10, further comprising fibers in communication with
said bag.
